(19) United States
(12) Patent Application Publication
(10) Pub. No.: US 2016/0148150 A1
(43) Pub. Date: May 26, 2016

(54) SYSTEM FOR MANAGING A COLLECTION OF OBJECTS SUCH AS THE STOCK OF CLOTHES AND ACCESSORIES OF A CLOTHING STORE

(71) Applicant: RETAIL RELOAD, Suresnes (FR)

(72) Inventors: Yves Curtat, Boulogne (FR); Roland Broutin, Mennecy (FR)

(21) Appl. No.: 14/784,869

(22) PCT Filed: Apr. 8, 2014
(86) PCT No.: PCT/FR2014/050837

§ 371 Date: Jan. 7, 2016

(30) Foreign Application Priority Data
Apr. 17, 2013 (FR) 1353477

(51) Int. Cl. G06Q 10/08; G06K 7/10

(52) U.S. Cl. CPC G06Q 10/087; G06K 7/10366

(57) ABSTRACT

System for managing a collection of objects, for example in a store, employing identification tags (RFID) assigned to object (O) locations and individual labels (ID-O) associated with the objects. The objects are identified using a portable label scanner (RFIDL) operating in either a local mode (M1) or in a single mode (M2), with said scanner being connected to a control unit (CPU) that controls the operation of the scanner. The local mode (M1) consists of reading the label (ID-Pⱼ) of the display location (Pⱼ) of a batch of objects (Oi) and of scanning the label of the objects located in this location for comparison and verification. The single mode (M2) is a close-up scan of the label of an object, taken individually.

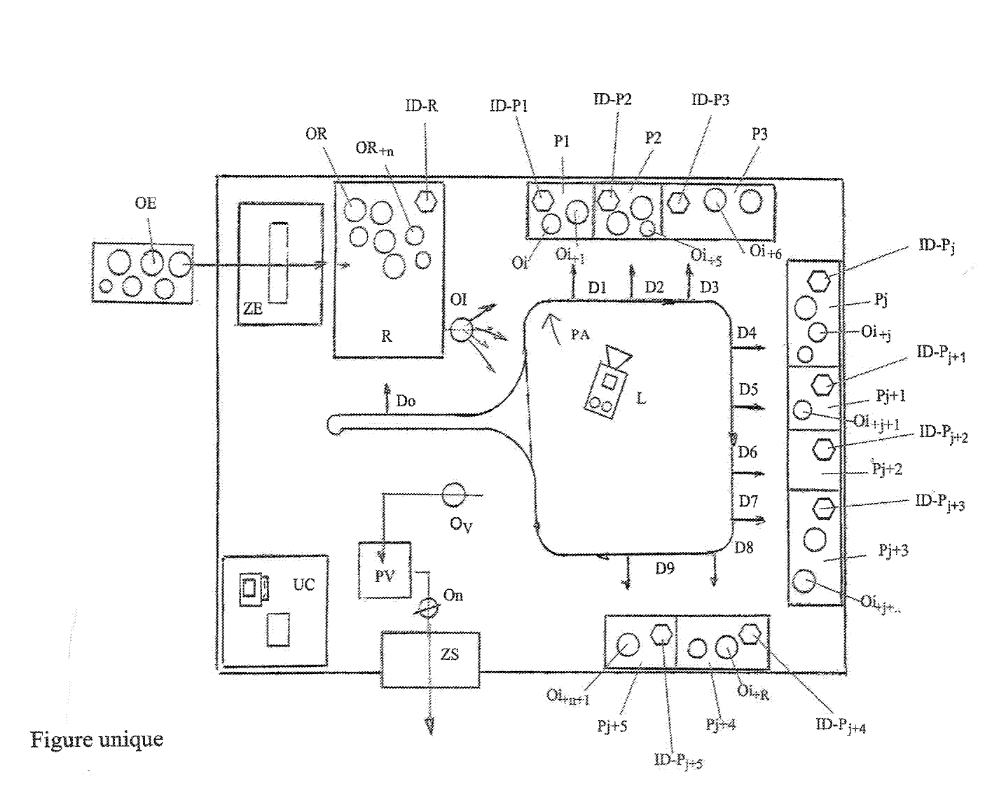

### FIELD OF THE INVENTION

The present invention relates to a management system (e.g. inventory management) of a collection of objects offered for sale, regardless of the domain, such as, for example, clothes and accessories of a clothing store, products and accessories sold in the domain of telephony and fast food.

### PRIOR ART

In some types of retail locations such as stores or boutiques for clothing, ready-to-wear clothes or various accessories, monitoring the clothing and any accessories offered for sale is often difficult between registering the objects in the inventory upon their arrival at the retail location and their exit because, in addition to possibly significant mark-downs, objects that are part of a batch also do not remain stationary and subsequently cannot be located for sale because they were moved by customers and placed in other batches.

For example, there may be batches of clothing presented by category according to the product type or the size.

In such frequent cases, only random chance or a methodical search of all the products will allow finding a misplaced product. This seemingly insurmountable situation, as far as the current state of the art is concerned, has significant disadvantages in costs since the misplaced product may not be sold as it is not available at the time of a possible sale or because of the significant search time or because of the arrival of a fresh stock.

This invention enables a “physical” management of objects.

### PURPOSE OF THE INVENTION

The purpose of this invention is to develop ways to locate objects in a collection of objects and then retrieve misplaced objects when needed in order to have them available immediately and/or to prevent them from being considered missing and thus not available for sale.

### PRESENTATION AND ADVANTAGES OF THE INVENTION

To this end, the purpose of the invention is a system for managing a collection of objects such as the inventory of clothes and accessories of a clothing store having fixed locations for object batches (display units) and/or where appropriate, a stockroom at the retail location, with the said system being characterised in that it comprises:
a set of labels identifying the locations in which the objects are kept,
a set of individual labels for the objects, assigned on arrival at the retail location and neutralised when leaving the retail location,
an entry area to identify the incoming objects and to assign them an individual identification label,
an exit area to neutralise the identification label,
at least one portable label scanner operating at least in local mode and in single mode,
a control unit,
   controlling the operating mode of the scanner based on the short or long scanning use,
   receiving the scanned information provided by the scanner for managing the inventory of objects and their locations:
      the entry of the objects and the assigning of an identification label,
      the distribution of the objects to the assigned locations,
      the exit of an object,
      the current location of the objects,
      the comparison between the current locations and the assigned locations,
the local mode consists of:
   scanning the label of the assigned presentation location,
   scanning the labels of the objects located at this location,
   comparing this scan with the previous scan and reporting a difference:
      absence of an object if it has not been neutralised through sale,
      presence of another object:
         this object being newly released from the stockroom or not newly released from the stockroom and is therefore reported as a misplaced object,
the single mode being a close-up scan of the label of an object and possibly the scanning of the label of the location from which the object was taken.

The collection management system as per the invention thus allows effectively knowing the inventory status as well as the location of the objects constituting the inventory such that any misplaced object, i.e. an object that was taken and not returned to its assigned location, can be found immediately. This management system greatly facilitates maintaining a retail location by thus enabling one to find the objects on sale, e.g. objects that are part of a batch (size, colour or shape of the object). This management system is particularly important in retail locations where objects are frequently taken, tried and looked at but not returned to their assigned location.

This system allows a very effective sales management because in case of an object missing from its assigned place, it is easy to find it or to know that the requested object is actually missing from the collection of objects available at the retail location, which therefore allows a very rapid restocking of a retail location.

One particular advantage of the invention is that it optimises sales for the merchant, in addition to preventing unpleasant waiting times for the customer.

Detecting the objects and their assigned locations is a very simple operation, which is almost automatic or at least does not require special attention because normally, the user performing a detection will direct his scanner, in the local scanning mode, first to the label of the location or the display unit and then to the batch of objects in that location.

Even if the scanning is conducted erroneously, i.e. if the user does not first point the scanner to the location label and passes immediately to scanning the batch of objects associated with the said location, the scanning error will be easily spotted. The scanning error may even be reported immediately to the operator since the signals that will have been sent to the central processing unit (CPU) will be immediately analysed and will thus show inconsistencies.

The CPU can thus define an area of inconsistency and request the operator to resume scanning the inventory at a given location.

Since the CPU systematically eliminates duplicates as each object is assigned a unique identity, the system according to the invention allows establishing a particularly reliable state of the inventory at any given time.

According to another advantageous feature, the scanner also works in a general mode to detect objects regardless of their location and to thus update the inventory by bulk scanning all of the object and location labels and subsequently removing the location labels as well as duplicates of the object labels.

The general mode provides an overview of the inventory. It can be compared with the local mode such that the local mode is either confirmed or denied by the result of the general mode or vice versa. It allows a daily or an even more frequent inventory, depending on the requirements, in view of its reliability and speed.

According to another advantageous feature, in the local mode, the scanner separately or successively scans the location label of a batch and the object labels at the said location, and then sends the information signals to the CPU which, on detecting a known object with no assigned location (first detection), assigns it the location where it was detected (pair). On detecting a known object having an assigned location, the CPU checks the object-location label pair and records its presence if the object is the one to which the detected location was assigned. If the object does not match the detected location, the CPU records the object as being misplaced and the location from which it has been moved, and if necessary, reports it. During a subsequent local scan, if there was no new object introduced in the collection of objects, the detection will only detect the missing objects if their label is not reported as neutralised or the misplaced objects if their identity and their assigned location do not match.

According to another advantageous feature, the scanner works in a single mode for a close-up detection of an object. This single mode may be used to detect an object at a location by individually detecting the label of the location and that of the object. This individual mode is particularly useful for processing a purchase and registering the object as sold in the CPU in order to update the status of the inventory. This also allows neutralising the label of the object sold at the time so that it can leave normally through the exit area without triggering a special alarm.

Conversely, the exit area allows detecting an object whose label is not neutralised in order to report this exit and possibly prevent it if it is a fraudulent mark-down.

In any event, the thus implemented invention especially allows scanning and managing customised inventories based on the user's needs.

### DRAWINGS

This invention will be described hereinafter in more detail using an example of a system for managing a collection of objects, shown in the accompanying drawing wherein the FIGURE is a design plan of a management system according to the invention in a retail location.

### DESCRIPTION OF AN EMBODIMENT OF THE INVENTION

According to the FIGURE, the invention concerns a system for managing a collection of objects which, in this example, consists of the inventory of clothing and accessories of a clothing store. To simplify the description, products such as clothes or accessories will be called “objects” and display racks, store windows and other places used to display objects, individually or in batches, will be called “display units”.

The retail location to which the invention applies consists of an entry area ZE for objects O, which feeds a stockroom R from which the objects are distributed to the various display units P. These display units of the retail location P1, P2, P3 . . . Pj, Pj+4 are store windows, hangers, drawers, etc.

The retail location is equipped with an exit area ZS through which the purchased objects Oₙ cross by passing through a point of sale PV, where the formalities of the sale take place, i.e. payment and registration of the object as sold Oᵥ.

The entire process is managed by a central processing unit CPU.

To simplify the presentation and description of the invention, we have used the following conventions of reference:
the objects generally have the reference O and depending on their situation in the retail location, they will have:
   the reference OE as an incoming object,
   the reference OI as an object identified by a RFID label,
   the reference OR . . . OR₊ₙ as objects in the stockroom R,
   the references Oi . . . Oi₊ₚ as an object at a location,
   the reference Oᵥ as a sold object,
   the reference Oₙ as a neutralised object,
the display units will generally have the reference P and depending on their situation:
   the individual references: P1 . . . P3 . . . Pj . . . Pj+4,
the RFID identification labels of locations P will have the general reference ID-P and particular references ID-P1 . . . ID-Pⱼ₄,
the stockroom label will be ID-R,
the RFID identification labels of the objects will have:
   the general reference ID-O,
   the individual reference ID-Oi . . . ID-Oi₊ₙ.

The management system according to the invention applies to the entry area ZE to identify incoming objects OE and to the exit area ZS to identify outgoing objects Oₙ as well as in the intermediate part consisting of the stockroom R and the display units P1-Pj+4.

The system according to the invention consists of a set of RFID location identification labels ID-L1 . . . ID-Lj . . . ID-Lⱼ₊₄ assigned to the various display units P1 . . . Pj+4. These ID-P location identification labels are assigned permanently to locations P as part of the organisation of the retail location and if this organisation changes, the ID-P location identification labels can be modified.

The system also includes a set of individual RFID labels, ID-O assigned to the objects O on their arrival at the retail location, e.g. in the entry area ZE. These ID-O labels may also be attached to objects OE upstream of the entry area ZE, it being specified that these ID-O identification labels are RFID labels that uniquely identify each object O. The system also includes one or more RFID label scanners L, each operating in a controlled manner in the local mode M1, or in the single mode M2, or possibly in the general mode M3.

The portable label scanner(s) L are associated with the management control unit CPU, which controls the operating mode M1-M3 of each scanner L and manages the scanned signals that the scanner L provides it with as described hereinafter.

The objects O identified and registered when they pass through the entry area ZE remain in either the stockroom R or pass through it to the display units P. Thus, each display unit P receives a to certain batch of objects Oi, Oi+1 (display unit P1), Oi+2 (display unit P2), etc. These objects O constitute batches associated with each of the display units P. This arrangement of the objects is based on commercial or aesthetic considerations for the presentation of objects in a store.

The label scanner L is used to scan the retail location, either in the local mode M1 or in the general mode M3. It can also scan in the single mode M2.

The operating mode M1-M3 of the scanner L is controlled by the central processing unit CPU in response to a request from the user of the scanner L or according to the automatic operating considerations programmed into the central processing unit CPU.

In the local mode M1, the user, e.g. the seller, moves the scanner L to detect the objects O present at each location P.

For this, the scanner L is pointed towards to the location, either the stockroom R or the display units P1 . . . P_{J+4}. The scanner L first scans the label ID-P identifying the location of the batch of objects and then stores the labels ID-O assigned to the objects Oi, Oi+1, etc. associated with each display unit P1, etc. This operation of scanning the location label ID-P and then that of the objects O at this location in the display unit P is continued until all of the locations P are processed. The scanned signals are transmitted to the central processing unit CPU for use. The central processing unit CPU first registers the ID-P, ID-O signals as locations P and objects O, and then conducts a search for the objects. Very schematically, the central processing unit CPU is programmed to compare the scan to that of the previous local mode M1. For each detected object:
If the detection relates to a known object O with no assigned location (first detection of the object), the central processing unit CPU assigns it the location P at which it was detected. The central processing unit CPU thus forms an object-location pair defined by the two labels (ID-Oi, ID-Pj) which, even in case of a reorganisation of the store products, remains permanently assigned to the object Oi unless there is an external intervention.
If the detection relates to the label of a known object having an assigned location, the central processing unit CPU checks its object-location pair and if it matches with the pair already associated with this object, there is no follow-up; the CPU simply registers that the object is in its place.
If, however, the CPU notes a difference between the scanned object-location label pair and that of the registered pair, it considers that the object has been moved and records the new position of the object Oi so that it can be found.

The central processing unit CPU can also report this misplaced object Oi via a list of misplaced objects with their misplaced address, in order to allow the store staff to put the object or objects back in their assigned location. This replacement can be done periodically.

In the meantime, if a request is made to find an object Oi, the central processing unit CPU can respond and report the moved object and the location where it can be found. If the product has changed places between two scans, the unit search will be used.

On the next scan, if there is no new object introduced in the inventory, the local detection M1 will count the objects O present at the site and the correlation between the state of the thus recorded objects and the previous state minus the sold objects, in order to thus detect any discrepancy between the two states.

Scanning in the local mode M1 can be done on a course PA that passes through the stockroom R and in front of the display units P1 . . . P_{J+4} or just in front of the display units P1 . . . P_{J+4}. The different detection points are simplified using references D0, D1 . . . D9.

This kind of detection in the local mode M1 can be done at any time, either systematically at the start of each day, or at the end of the day, or at intervals of one or two days, or even a week, or furthermore according to other schedules. Scanning in the local mode M1 can also be done during off-peak periods when there are no customers in the store.

The single mode M2 is a close-up scanning mode consisting of scanning the label ID-Oi of a single object, e.g. at the time of a transaction, in order to identify the item sold Oᵥ, to establish the invoice and to neutralise its label, and also to register it as sold and as no longer being part of the inventory, i.e. neutralising it Oₙ.

The object Oₙ is then free to pass through the exit area ZS.

The general mode M3 is a bulk scanning of all objects O on the site. This scan focuses on either the stockroom R and the display units P, or only the stockroom R, or only the display units P insofar as the objects O are managed differently depending on whether they are in the stockroom or in the display units.

This general scanning M3 detects all ID-P, ID-O labels, those identifying locations as well as those identifying objects. This detection has the disadvantage of redundancy, via providing double readings or more, due to the reflection of the electromagnetic waves.

These signals are transmitted to the central processing unit CPU, which filters them to delete the location labels ID-P insofar as it only seeks to identify the objects O constituting the inventory at the retail location. The central processing unit CPU also deletes duplicates and other similar readings corresponding to the multiple scanning of the same ID-O label so that only one scan of a label is preserved per object.

This scanning n the global mode M3 allows knowing the objects in the inventory, comparing this state to the previous state and detecting any discrepancies. Due to the global nature of the scan, this detection in the general mode M3 cannot identify misplaced objects.

The invention has been described above in the case of a retail location consisting of a store with a collection of objects that are moved often and that have a market value that requires a precise control of the state of the inventory. The invention can be applied to a variety of other collections of objects in retail locations such as, for example, retail outlets where products must be constantly stored and reorganized, or old bookstores where the books are classified by subjects but are often removed from their display unit for viewing and are not put back in their place or are misplaced and thus require a search that would prove tedious if there are a large number of objects.

It is applicable to a store or group of stores if all of the stores are equipped with the same solution, which allows executing exchanges, optimising the inventory, crossing out products with reservations on the unique ID of the product, thus guaranteeing its presence and the impossibility of selling this product since a voluntary action has not “released” this reserved product.

This invention (equipment and management software) of the RFID also enables communicating with all computer devices on the market (PC, Tablet, Smartphone, etc.), which allows all publishers of software usable on this type of equipment (not designed for use in the RFID mode in shops) to benefit from the possibilities of using them and thus expanding their market to that of commerce transactions (payment, taking orders, development of inventory applications, etc.).

### NOMENCLATURE

O Object
OE Incoming object
Oi Object identified by a label
OR Object in the stockroom
Oᵥ Sold object
Oₙ Neutralised object
P Display unit
P1 . . . Pⱼ Individual display units
ID-P Label of a location
ID-Pi Identification label of a location
ID-R Label of the “stockroom” location
ID-O General label of an object
ID-O . . . ID-O₊ᵢₙ Special reference of the object
L RFID label scanner
M1 Local mode
M2 Single mode
M3 General mode
CPU Central processing unit
ZE Entry area
ZS Exit area
PA Detection path
D1-D9 Scanning points of locations Pi

1-3. (canceled)

4. A system for managing a collection of objects in a retail location having fixed locations for object batches and a stockroom, said system comprising:
a set of identification labels (RFID) of respective locations (ID-P) in which the objects (O) are kept:
a set of individual labels for the objects (ID-O), the individual labels assigned on arrival at the retail location and neutralized when leaving the retail location;
an entry area (ZE) to identify incoming objects (OE) and to assign to the incoming objects an individual identification label (RFID, ID-Oi);
an exit area (ZS) to neutralize identification labels (ID-Oi);
at least one portable label scanner (RFIDL) operable in a local mode (M1) and in a single mode (M2);
a control unit (CPU), the control unit:
controlling an operating mode (M1-M3) of the scanner (L); and
receiving scanned information provided by the scanner (L) for managing an inventory of objects (O) and respective locations (P), including:
entry of the objects (OE) and assigning of an identification label (RFID, ID-Oi) to respective objects;
distribution of the objects (O) to the assigned locations (P);
exit of an object (Oₙ); and
current locations of the objects (ID-Pⱼ);
comparisons between respective current locations and assigned locations of the objects; wherein
the local mode (M1) comprises the following steps:
scanning the label (ID-P) of the location (PI) where a batch of objects (Oi) is presented; and
scanning the labels (ID-Oi) of the objects located at the location;
comparing with a previous scan and reporting a difference, including
an absence of an object if the object has not been neutralised through sale;
a presence of another object (Oi), including:
the other object being newly released from the stockroom (R); and
the other object not being newly released from the stockroom and therefore being reported as a misplaced object; and
the single mode (M2) being a close-up scan of one of the label of an object and a scanning of the label of the location from which the object was taken.

5. The system of claim 4, wherein the scanner (L) is also operable in a general mode (M3) to detect objects (Oi) regardless of their location (Pⱼ) and to update the inventory by bulk scanning all of the object (ID-Oi) and location (ID-Pⱼ) labels followed by removing the location labels as well as duplicates of the object labels.

6. The system of claim 4, wherein:
in the local mode (M1), the scanner (L) one of separately and successively scans the location label (ID-Pⱼ) of a batch and the respective labels (ID-Oi) of the objects (0) at the location (Pⱼ), followed by sending information signals to the central processing unit (CPU) which, on detecting a known object with no assigned location, assigns the object a location where the object was detected (ID-Oi; ID-Pⱼ pair), and wherein:
on detecting a known object having an assigned location, the central processing unit (CPU) checks the object-location label pair and records a presence if the object is the object to which the detected location was assigned; and
if the object (Oi) does not match the detected location, the central processing unit (CPU) records the object as being misplaced and the location from which it has been moved (ID-Pⱼ); and if necessary, reports it; and
during a subsequent local scan (M1), if there was no new object introduced in the collection of objects, the detection will only detect at least one of:
missing objects if the labels of the missing objects are not reported as neutralised; and
misplaced objects if their identity and their assigned location do not match.
